(19) United States
(12) Patent Application Publication
(10) Pub. No.: US 2012/0228308 A1
(43) Pub. Date: Sep. 13, 2012

(54) Pressure Vessel

(76) Inventor: Han-Chin Lai, Taichung City (TW)

(21) Appl. No.: 13/414,860

(22) Filed: Mar. 8, 2012

(30) Foreign Application Priority Data
Mar. 11, 2011 (TW) 100108351

(51) Int. Cl. F17C 1/00

(52) U.S. Cl. 220/581

(57) ABSTRACT

A pressure vessel includes: two housing-flange segments extending from axially-opposite end portions of a housing segment, respectively; a diaphragm segment disposed in the housing segment, having axially-opposite end portions; two diaphragm-flange segments extending from the end portions of the diaphragm segment, respectively; and two water fitting units each having a fitting-flange segment that cooperates with an adjacent one of the housing-flange segments to clamp an adjacent one of the diaphragm-flange segments therebetween, and fluidly communicating a water chamber that is defined in the diaphragm segment with an external environment via a port.

### CROSS-REFERENCE TO RELATED APPLICATION

This application claims priority of Taiwanese Application No. 100108351, filed on Mar. 11, 2011.

### BACKGROUND OF THE INVENTION

1. Field of the Invention

The invention relates to a pressure vessel, more particularly to an in-line pressure vessel.

2. Description of the Related Art

Currently, hydro-pneumatic pressure vessels are widely employed in industrial and residential piping systems. For example, hydro-pneumatic pressure vessels are used in stabilizing water pressure and absorbing water hammer in hydraulic piping systems, controlling thermal expansion in closed-loop hot water systems, and storing water in reverse osmosis systems.

U.S. Pat. No. 7,363,944 discloses such a conventional hydro-pneumatic pressure vessel, which includes a vessel unit and a rubber diaphragm disposed in the vessel unit for dividing an inner space of the vessel unit into a water chamber and an air chamber. A water fitting and an air valve are disposed on the vessel unit and configured for communicating fluidly and respectively with the water chamber and the air chamber. Since the conventional hydro-pneumatic pressure vessel only has one water fitting for inlet and outlet of water, it is not suitable for use in an in-line piping system. Moreover, the conventional hydro-pneumatic pressure vessel lacks a fresh circulation of water when used for storing potable water.

A conventional in-line pressure vessel disclosed in U.S. Pat. No. 6,418,969, which may be used to provide fresh circulation of water, includes: a tubular container; an water inlet fitting and a water outlet fitting secured respectively to opposite ends of the tubular container; a tubular diaphragm disposed in the tubular container and having opposite end portions that are connected respectively to the water inlet and water outlet fittings; and an inner pipe disposed in the diaphragm and having opposite end parts that are connected respectively to the water inlet and water outlet fittings. However, since the diaphragm is shorter in length than the tubular container and must be secured tightly to the water inlet and water outlet fittings to prevent leakage of water, and since the tubular container and the water inlet and water outlet fittings must be in an airproof connection with the tubular container to prevent leakage of air, the conventional in-line pressure vessel is relatively complex in structure and costly to make.

Another conventional pressure vessel disclosed in U.S. Pat. No. 7,108,015 is similar in structure and hence in drawback to the abovementioned in-line pressure vessel disclosed in U.S. Pat. No. 6,418,969.

### SUMMARY OF THE INVENTION

Therefore, the object of the present invention is to provide an in-line pressure vessel that has a relatively simple structure and that is easy to assemble.

Accordingly, a pressure vessel of the present invention includes:

a housing unit having
a housing segment that surrounds an axis, and that has axially-opposite end portions, and
a pair of housing-flange segments that extend respectively from the end portions of the housing segment in a radially outward direction with respect to the axis;

an elastic diaphragm unit having
a substantially barrel-shaped diaphragm segment that is substantially disposed in the housing segment, that has axially-opposite end portions corresponding respectively in position to the end portions of the housing segment, that defines a water chamber therein, and that cooperates with the housing segment to define an air chamber therebetween, and
a pair of diaphragm-flange segments that extend respectively from the end portions of the diaphragm segment in the radially outward direction such that each of the housing-flange segments is substantially interposed between the housing segment and an adjacent one of the diaphragm-flange segments; and

a pair of water fitting units that are respectively disposed corresponding to the diaphragm-flange segments, each of the water fitting units having a fitting-flange segment that cooperates with an adjacent one of the housing-flange segments to clamp an adjacent one of the diaphragm-flange segments therebetween, and being formed with a water port for fluidly communicating the water chamber with an external environment.

### BRIEF DESCRIPTION OF THE DRAWINGS

Other features and advantages of the present invention will become apparent in the following detailed description of the preferred embodiment with reference to the accompanying drawings, of which:

FIG. 1 is a partly sectional view of a preferred embodiment of a pressure vessel according to the invention, illustrating an empty water chamber;

FIG. 2 is an enlarged fragmentary sectional view of the preferred embodiment; and

FIG. 3 is another partly sectional view of the preferred embodiment, illustrating the water chamber filled with water.

### DETAILED DESCRIPTION OF THE PREFERRED EMBODIMENT

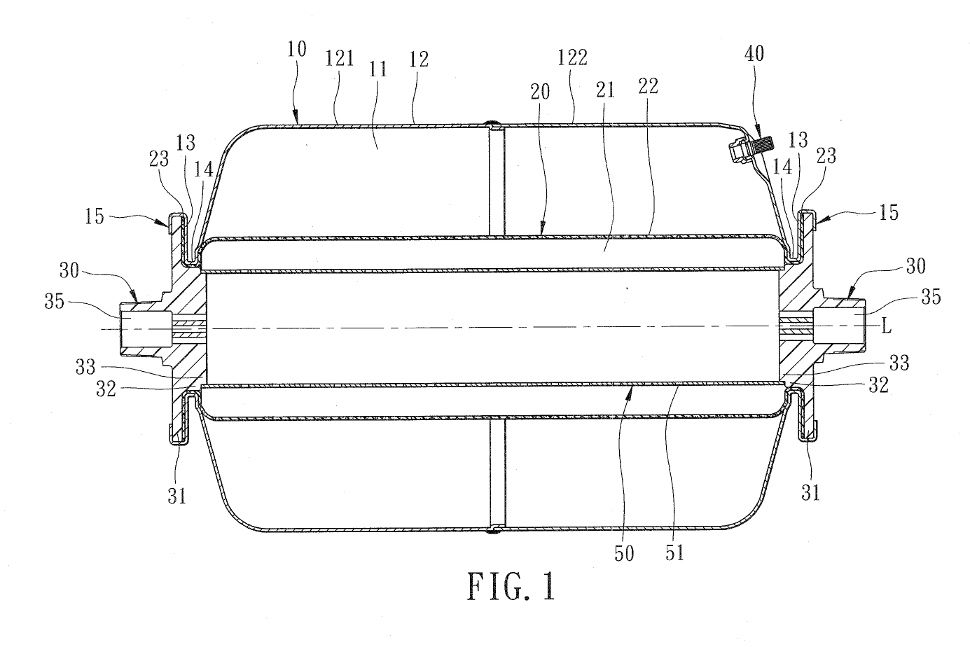

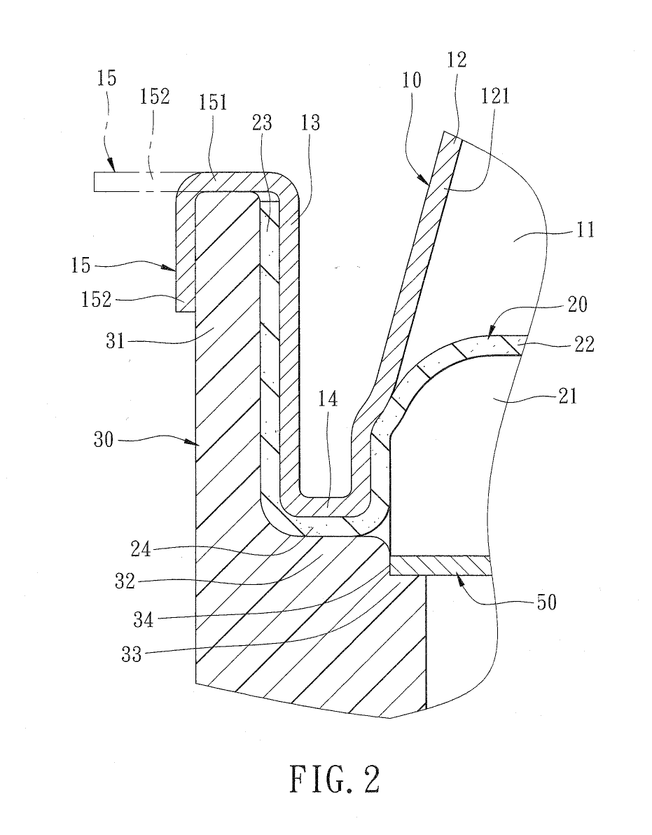

As shown in FIGS. 1 and 2, the preferred embodiment of a pressure vessel according to the present invention includes a housing unit 10, an elastic diaphragm unit 20, a pair of water fitting units 30, a pair of securing units 15, an air valve 40 and a restricting pipe 50.

The housing unit 10 has a housing segment 12 that surrounds an axis (L), that has axially-opposite end portions, and that is comprised of first and second housing portions 121, 122 that are welded together. However, implementation of the housing segment 12 is not limited to such. Each of the end portions of the housing segment 12 has a neck section 14. The housing unit 10 further has a pair of housing-flange segments 13 that extend respectively from the neck sections 14 of the end portions of the housing segment 12 in a radially outward direction with respect to the axis (L).

The diaphragm unit 20 is preferably made of rubber, and has a substantially barrel-shaped diaphragm segment 22 that is substantially disposed in the housing segment 12, that has axially-opposite end portions corresponding respectively in position to the end portions of the housing segment 12, that defines a water chamber 21 therein, and that cooperates with the housing segment 12 to define an air chamber 11 therebetween. Each of the end portions of the diaphragm segment 22 has a neck section 24.

The diaphragm unit 20 further has a pair of diaphragm-flange segments 23 that extend respectively from the neck sections 24 of the end portions of the diaphragm segment 22 in the radially outward direction such that each of the housing-flange segments 13 is substantially interposed between the housing segment 12 and an adjacent one of the diaphragm-flange segments 23.

The water fitting units 30 are disposed corresponding to the diaphragm-flange segments 23, respectively. Each of the water fitting units 30 has a fitting-flange segment 31 that cooperates with an adjacent one of the housing-flange segments 13 to clamp air-tightly an adjacent one of the diaphragm-flange segments 23 therebetween, and is formed with a water port 35 for fluidly communicating the water chamber 21 with an external environment. In application, the pressure vessel may be configured such that one of the water fitting units 30 serves as a water inlet, and the other of the water fitting units 30 serves as a water outlet.

Each of the fitting-flange segments 31 has a supporting portion 32 extending toward the water chamber 21, and cooperating with the neck section 14 of the adjacent one of the end portions of the housing segment 12 to clamp air-tightly the neck section 24 of the adjacent one of the end portions of the diaphragm segment 22 therebetween. Each of the fitting-flange segments 31 further has an extending portion 33 that extends from the supporting portion 32 into the water chamber 21, and a shoulder portion 34 that interconnects the supporting portion 32 and the extending portion 33. The restricting pipe 50 is disposed in the water chamber 21, fluidly communicates the water ports 35 of the water fitting units 30 to each other, and is formed with a plurality of holes 51 for fluid communication through the holes 51. The restricting pipe 50 has opposite end segments sleeved fittingly onto the extending portions 33 and abutting against the shoulder portions 34 of the fitting-flange segments 31, respectively.

Preferably, when the neck sections 24 of the diaphragm segment 22 are respectively clamped between the neck sections 14 of the housing segment 12 and the supporting portions 32, the neck sections 24 are compressed, i.e., thicknesses of the neck sections 24 are reduced, thereby sealing off air flow between the neck sections 24 of the diaphragm segment 22 and the neck sections 14 of the housing segment 12, and water flow between the neck sections 24 and the supporting portions 32.

Each of the housing-flange segments 13 has a distal end distal from the housing segment 12 and extending beyond the adjacent one of the diaphragm-flange segments 23 and the adjacent one of the fitting-flange segments 31 in the radially outward direction with respect to the axis (L). Each of the securing units 15 has: a first segment 151 extending from the distal end of the respective one of the housing-flange segments 13 in a direction along the axis (L) and away from the housing segment 12, and having a distal end distal from the distal end of the respective one of the housing-flange segments 13; and a second segment 152 extending from the distal end of the first segment 151 in a radially inward direction with respect to the axis (L), and cooperating with the respective one of the housing-flange segments 13 to clamp the respective one of the diaphragm-flange segments 23 therebetween. In this embodiment, each of the securing units 15 is integrally connected to the respective one of the housing-flange segments 13, and each of the first and second segments 151, 152 thereof surrounds the axis (L). Thus, the securing units 15 secure the fitting-flange segments 31 to the housing-flange segments 13, respectively.

As illustrated in FIG. 2, in this embodiment, each of the securing units 15 is implemented as having an opened state (depicted by broken line), where the second segment 152 is configured to be parallel to the corresponding first segment 151 so as to enable assembly and disassembly of the corresponding water fitting unit 30 to and from the housing unit 10 and the diaphragm unit 20, and a closed state (depicted by solid line), where the second segment 152 is configured to be perpendicular to the corresponding first segment 151 so as to secure the corresponding water fitting unit 30 to the housing unit 10 and the diaphragm unit 20.

The air valve 40 is disposed on the second housing segment 122 and disposed corresponding to the air chamber 11, and communicates fluidly the air chamber 11 with the external environment.

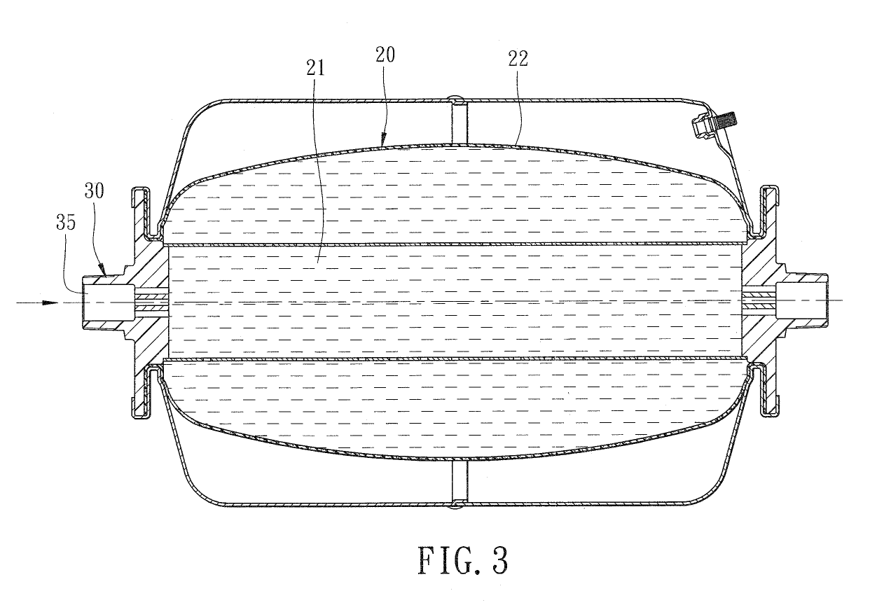

When the water chamber 21 is empty (see FIG. 1), the diaphragm segment 22 is not expanded. When water is introduced into the water chamber 21 via the water port 35 of one of the water fitting units 30, the diaphragm segment 22 of the diaphragm unit 20 is expanded for storing water (see FIG. 3).

It should be noted that the air valve 40 may be omitted in a modification in which inflation of the air chamber 11 is achieved through sublimation of solid carbon dioxide in the air chamber 11. Moreover, each of the securing units 15 may be configured to include a bolt and a nut for securing the corresponding housing-flange segment 13 to the corresponding fitting-flange segment 31.

In summary, the pressure vessel of the present invention has the following advantages.

1. By virtue of the dual water fitting units 30, the pressure vessel may be configured for use in an in-line piping system. In the use of storing portable water, such a pressure vessel provides a relatively fresh water circulation.

2. The diaphragm unit 20 is clamped tightly between the housing unit 10 and the water fitting units 30 so the connection among the abovementioned units 10, 20, is air-tight and water-tight without additional air-tight and water-tight configuration.

3. Specifically, the firm, air-tight sealing between the neck sections 24 of the diaphragm segment 22 and the neck sections 14 of the housing segment 12 prevents air leakage of the air chamber 11 therethrough, and that between the neck sections 24 and the supporting portions 32 prevents water leakage of the water chamber 21 therethrough.

4. When water is discharged from the water chamber 21, the restricting pipe 50 prevents over-contraction of the diaphragm segment 22 and stabilizes water flow through the water fitting units 30.

5. The pressure vessel of this invention has a relatively simple structure and is easy to assemble and disassemble.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A pressure vessel comprising:
a housing unit having
a housing segment that surrounds an axis, and that has axially-opposite end portions, and
a pair of housing-flange segments that extend respectively from said end portions of said housing segment in a radially outward direction with respect to the axis;
an elastic diaphragm unit having
a substantially barrel-shaped diaphragm segment that is substantially disposed in said housing segment, that has axially-opposite end portions corresponding respectively in position to said end portions of said housing segment, that defines a water chamber therein, and that cooperates with said housing segment to define an air chamber therebetween, and
a pair of diaphragm-flange segments that extend respectively from said end portions of said diaphragm segment in the radially outward direction such that each of said housing-flange segments is substantially interposed between said housing segment and an adjacent one of said diaphragm-flange segments; and
a pair of water fitting units that are respectively disposed corresponding to said diaphragm-flange segments, each of said water fitting units having a fitting-flange segment that cooperates with an adjacent one of said housing-flange segments to clamp an adjacent one of said diaphragm-flange segments therebetween, and being formed with a water port for fluidly communicating said water chamber with an external environment.

2. The pressure vessel as claimed in claim 1, wherein:
each of said end portions of said housing segment has a neck section, said housing-flange segments extending respectively from said neck sections of said end portions of said housing segment;
each of said end portions of said diaphragm segment has a neck section, said diaphragm-flange segments extending respectively from said neck sections of said end portions of said diaphragm segment; and
said fitting-flange segment of each of said water fitting units has a supporting portion extending toward said water chamber and cooperating with said neck section of the adjacent one of said end portions of said housing segment to clamp said neck section of the adjacent one of said end portions of said diaphragm segment therebetween.

3. The pressure vessel as claimed in claim 2, further comprising a pair of securing units connected to said housing-flange segments, and configured for securing said fitting-flange segments to said housing-flange segments, respectively.

4. The pressure vessel as claimed in claim 3, wherein:
each of said housing-flange segments has a distal end distal from said housing segment and extending beyond the adjacent one of said diaphragm-flange segments and the adjacent one of said fitting-flange segments in the radially outward direction with respect to the axis; and
each of said securing units has
a first segment extending from said distal end of the respective one of said housing-flange segments in a direction along the axis and away from said housing segment, and having a distal end distal from said distal end of the respective one of said housing-flange segments, and
a second segment extending from said distal end of said first segment in a radially inward direction with respect to the axis, and cooperating with the respective one of said housing-flange segments to clamp the respective one of said diaphragm-flange segments therebetween.

5. The pressure vessel as claimed in claim 4, wherein one of said first and second segments of one of said securing units surrounds the axis.

6. The pressure vessel as claimed in claim 4, wherein each of said securing units is integrally connected to the respective one of said housing-flange segments.

7. The pressure vessel as claimed in claim 1, further comprising a restricting pipe disposed in said water chamber, fluidly communicating said water ports of said water fitting units to each other, and formed with a plurality of holes for fluid communication through said holes

8. The pressure vessel as claimed in claim 7, wherein:
said fitting-flange segment of each of said water fitting units has a supporting portion that extends toward said water chamber, an extending portion that extends into said water chamber, and a shoulder portion that interconnects said supporting portion and said extending portion; and
said restricting pipe has opposite end segments sleeved fittingly onto said extending portions and abutting against said shoulder portions of said fitting-flange segments, respectively.

9. The pressure vessel as claimed in claim 1, further comprising an air valve disposed on said housing segment, and communicating fluidly said air chamber with the external environment.

10. The pressure vessel as claimed in claim 1, wherein said housing segment includes a first housing portion and a second housing portion welded to said first housing portion.
